(19) United States
(12) Patent Application Publication
(10) Pub. No.: US 2004/0184106 A1
(43) Pub. Date: Sep. 23, 2004

(54) Hybrid printer driver for color and black and white print-job splitting

(75) Inventor: Andrew R. Ferlitsch, Tigard, OR (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/394,786

(22) Filed: Mar. 21, 2003

(51) Int. Cl. G06K 15/02; G06F 3/12; H04N 1/40; H04N 1/52

(52) U.S. Cl. 358/2.1; 358/1.13

(57) ABSTRACT

A printer driver, hybridized to present, itself a single, compact, comprehensive and flexible user interface, uniquely sits in the data stream of a plural-mode print-job, operating on that job to split it appropriately into a correct plurality of respective single-mode print jobs. Each split job is individually and fully “attended to” by this driver, with respect to passing it outwardly for priority under the control of precision-fit driver-supplied printing controls and commands.

### BACKGROUND AND SUMMARY OF THE INVENTION

This invention relates to the handling of a plural-mode print job, such as a mixed black-and-white and color print job, and more particularly, to a method and a system for splitting such a job into plural single-mode jobs. In accordance with overall principles of the invention, and from a methodologic point of view, the invention involves encountering, or engaging, a plural, mixed-mode print job, and, utilizing an appropriate single, plural-mode printer driver, splitting that mixed-mode job into plural, single-mode print jobs. The word “print” herein is intended to mean, more broadly, various kinds of imaging, and encompasses printing, scanning, faxing and other like tasks. Accordingly, the words “print”, “printer”, “printing device”, and “printing”, unless clearly indicated to the contrary, contextually or otherwise, should be read with this broader-based meaning in mind.

In a specific illustration of the invention, the system and method of this invention feature a novel hybrid printer driver, such as a hybrid black-and-white and color driver, which encounters, or engages, a mixed-mode print job of the type generally mentioned above, and splits this mixed job, in the case of black-and-white and color, into two print jobs, one of which is a black-and-white print job, and the other of which is a color print job. The proposed hybrid driver operates completely independently of the specific format of data contained in the print job, operates independently of downstream print sub-systems that are positioned to receive driver-split print jobs, and presents itself to a user essentially as a single, mixed-mode interface. In this interface, a user can specify all of the necessary controls, instructions, requirements, etc., to assure delivery of the split job appropriately to compatible, downstream devices, such as black-and-white and color printers, respectively. The setting of handling a mixed black-and-white and color print job is employed here as an illustration, inasmuch as this setting is widely experienced in the art, and provides a clear demonstration of the nature and utility of the invention. References to black-and-white and color are not intended to be limiting, nor to suggest that the invention is purely focused on splitting just a dual-mode job into two single-mode jobs.

With regard to conventional practice, when, for example, a print job contains a mixture of color and black-and-white pages, and thus is traditionally, and according to one familiar process, sent to a color printer for the handling of both of these requirements, the cost may be unnecessarily high, often because of the fact that it is typical that such a job includes far more black-and-white content than it does color content. Additionally, color printing devices typically operate more slowly than do counterpart black-and-white devices. Thus, when a job which contains mixed black-and-white and color pages is sent to a color printer, it takes far longer to complete than were it to be dividedly handled, with black-and-white pages being handled by a typically faster black-and-white printing device, and the smaller color content pages, that is smaller in number, handled by a color printer. If another conventional practice involving hand splitting of a job is employed, this can turn out to be a quite expensive and time-consuming operation also.

These and other conventional practices are based upon a compromise which results in a failure to optimize printing for each mode in a mixed-mode job. The present invention changes this current situation. It does so by offering the utility of a novel hybrid printer driver which appropriately splits a mixed-mode print job into plural, single-mode jobs. This driver, after splitting a job, opens dedicated output connections for the mode-specific despooling of the different, individual print job modes to the proper, compatible printer.

The various features and advantages of this invention will become more fully apparent as the description which now follows is read in conjunction with the accompanying drawings.

### DESCRIPTION OF THE DRAWINGS

FIG. 1A is a high-level, block/schematic diagram illustrating the structure and method of the present invention.

FIG. 1B is another high-level block/schematic diagram, partly fragmentary, illustrating a system and a methodology constructed in accordance with the present invention in the context of splitting a mixed-mode black-and-white and color print job.

FIG. 2 illustrates a single user interface which is initially provided to a user with respect to a plural-mode hybrid printer driver constructed and operating in accordance with the present invention. The driver pictured in this figure is designed to split a mixed black-and-white and color print job.

FIG. 3 illustrates further details of the hybrid printer driver generally pictured in FIG. 2, and very specifically illustrates certain common options that are made available to a user, which options are likely to be common to all modes of printing that are to be handled by this hybrid driver. As was mentioned just above with reference to FIG. 2, the particular driver illustrated in FIGS. 2 and 3 is a dual-mode driver designed to handle, on the one hand, a black-and-white print job output from a mixed black-and-white and color input job data stream, and on the other hand, a color output print job also derived from the same input, mixed-mode print job.

FIG. 4 illustrates color rendering/output options, and rendering/trays associated with the “color side” of the proposed hybrid driver of this invention.

FIG. 5 is similar to FIG. 4, except that what is shown here relates to black-and-white output/rendering options and associated rendering and trays.

FIG. 6 illustrates operation of the hybrid driver of this invention with respect to the separation of a mixed mode, black-and-white and color print job into logical pages.

FIG. 7, which should be read as a diagram picking up a flow of operation from what is the bottom side of FIG. 6, illustrates operation of the hybrid driver of this invention with respect to color print job generation as one of the two single-mode output jobs resulting from the job splitting activity of the driver.

FIG. 8 is similar in a way to FIG. 7 in that it should be read as a flow of activity continuing from the bottom side of FIG. 6, but here illustrates operation of the hybrid driver of this invention with respect to a split, black-and-white print job generation.

FIG. 9 is a view which should be read as expressing a flow of activity progressing from the bottom side of FIG. 8, further illustrating downstream operation of the hybrid driver of this invention.

FIG. 10 is a block/schematic diagram illustrating de-spooling of a color print job output from the hybrid printer driver of this invention.

FIG. 11 is similar to FIG. 10, except that here what is illustrated is de-spooling of a black-and-white split print job output derived from the hybrid printer of this invention.

### DETAILED DESCRIPTION OF THE INVENTION

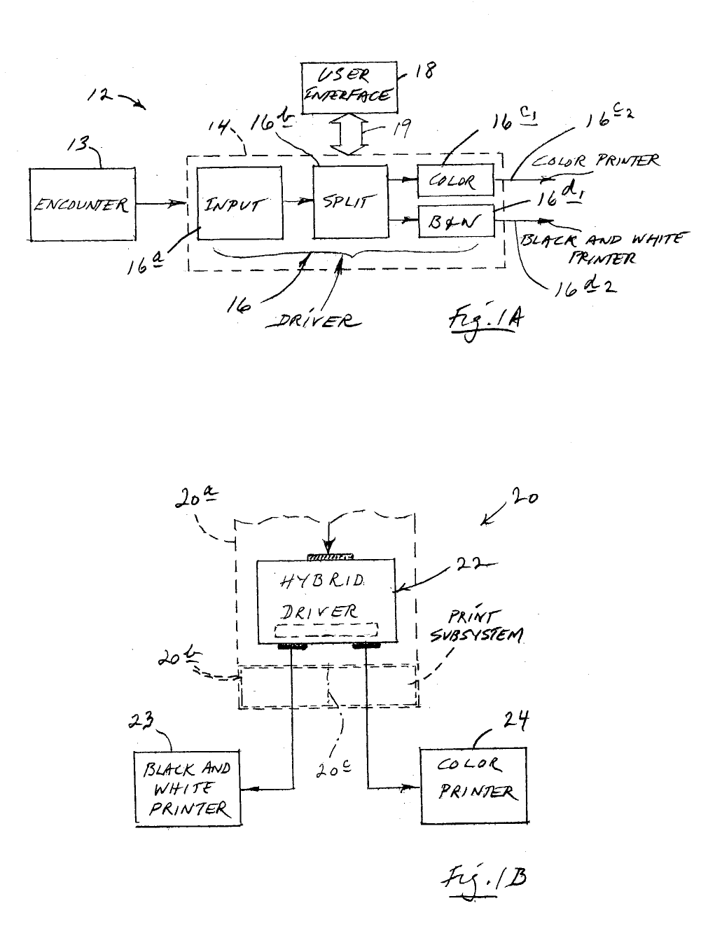

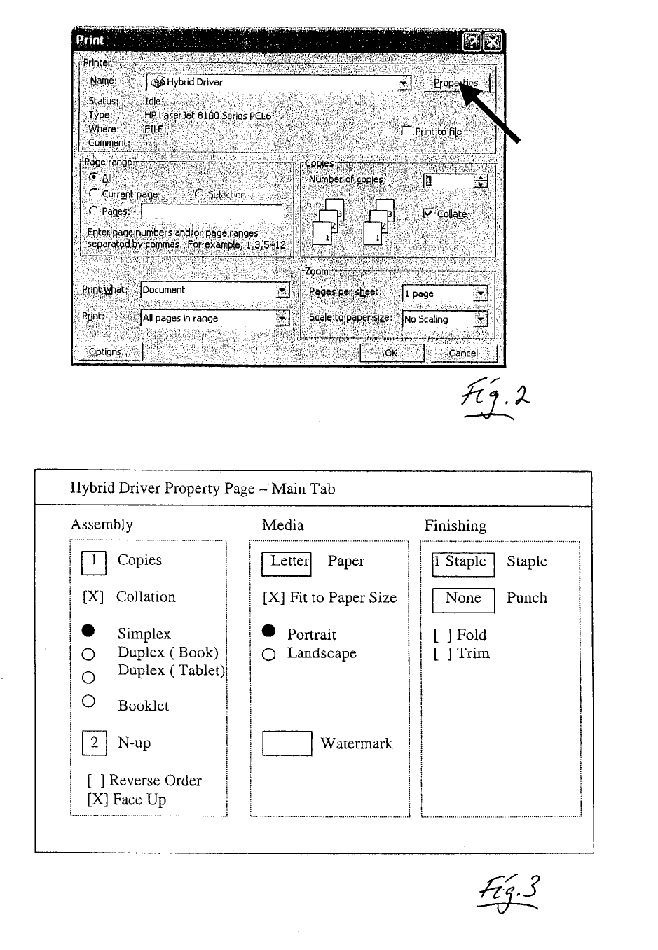

Turning now to the drawings, and referring first of all to FIG. 1A, indicated generally at 12 are a system and a methodology, as proposed by the present invention, for handling a plural-mode, mixed-mode print job. From a systemic point of view, system 12 is illustrated as including a block 13, called herein an encountering structure, and also an upstream data-stream structure, that acts to encounter, or engage, a mixed-mode print job, a block 14 which constitutes herein a utilizing structure, a hybrid printer driver 16 contained within block 14, and a single-menu user interface 18 which may be an interactive visual presentation on the display screen in a work-station computer.

Hybrid driver 16 includes an input side, represented by a block 16a, a splitting structure, or splitter, represented by a block 16b, and an output side, represented by two blocks 16c1, and 16d1, which are individually referred to herein, respectively, as a color output region and a black-and-white output region in the driver.

Blocks 16c1, 16d1 are associated with output connections 16c2, 16d2, respectively, which are collectively referred to herein as a downstream data-stream structure, and individually as a color data-stream substructure, and as a black-and-white data-stream substructure, respectively.

Operative interconnections between various ones of theses several “components” are represented by appropriate single-headed arrows. A large, double-headed arrow 19 represents a two-way, operative interconnection between splitter 16b and user interface 18. The region in FIG. 1A where a connection is shown between blocks 13, 16a is referred to herein as a downstream region relating to block 13.

The operation of system 12 involves the encountering by block 13 of a mixed-mode print job, such as a mixed black-and-white and color print job.

The encountered print job is fed to utilizing structure 14 through driver input block 16a, and is split by splitter 16b into two single-mode print jobs, one of which is a black-and-white print job, and the other of which is a color print job. This split job is output to appropriate external color and black-and-white printers (not shown) via components 16c1, 16c2 and 16d1, 16d2 respectively.

A user configures these two output jobs via single user interface 18 (still to be described) and a connection 19 which extends operatively between this interface and driver splitter 16b.

Shifting now to FIG. 1B, shown here generally at 20, with a somewhat different level of detail than that employed in FIG. 1A, and with a slightly different point of view, are a system and a methodology like those pictured, respectively, in FIG. 1A, proposed by the present invention for the handling of plural-mode, or mixed-mode, print jobs. The system and methodology shown at 20 in FIG. 1B, as was the case for system 12 in FIG. 1A, are presented in the context of handling a dual-mode, mixed-mode print job which includes mixed black-and-white and color components. Included in system 20 is a hybrid printer driver 22 constructed and operating in accordance with a preferred and best mode embodiment and practice of the present invention. This driver effectively “sits” in a print data flow stream which passes through system 20 from upstream system sub-components, generally shown by single-line dashed lines 20a, to a downstream print sub-system, shown by double-line dashed lines 20b. These terms “upstream” and “downstream” are expressed herein in terms, generally speaking, relative to the location in system 20 of driver 22. A dash-dot line 20c divides downstream region 20b into two sub-regions, the left one of which pertains to downstream structure which feeds a split black-and-white print job to a black-and-white printer 23, and the right one of which pertains to downstream structure which feed a split color print job to a color printer 24.

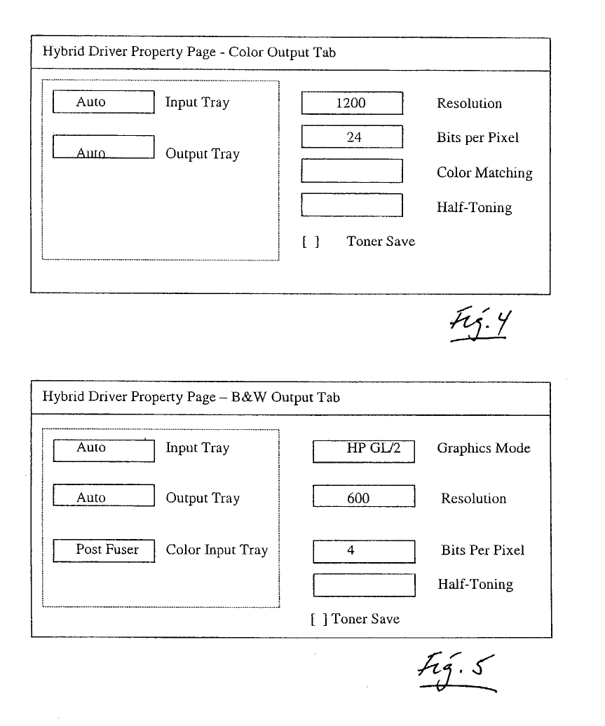

As has already been mentioned herein, hybrid printer driver 22 represents a plural-mode (a dual-mode in the illustration now being given) but single control interface to a user, for example on the screen of a display which forms part of a user workstation. FIGS. 2-5, inclusive, show details of a preferred embodiment of such an interface, and accordingly, continuing description now of the present invention, progresses first with reference to these particular drawing figures.

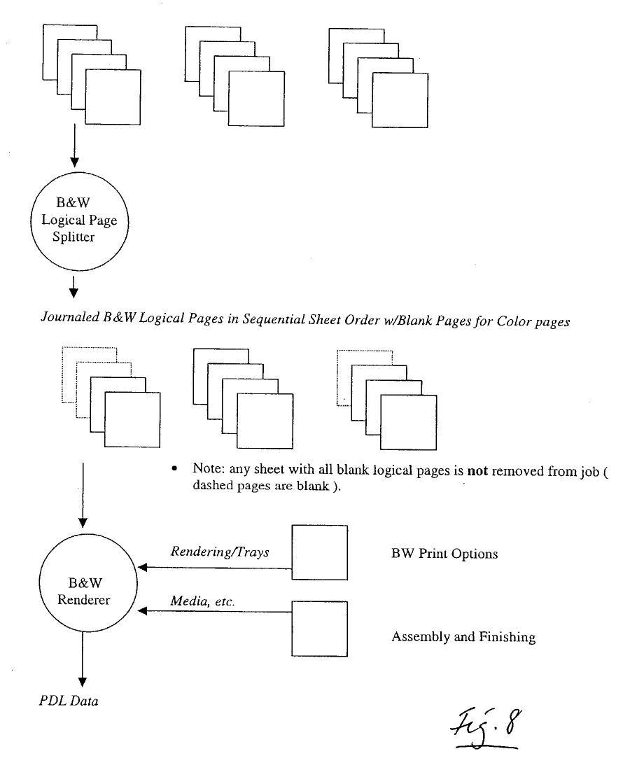

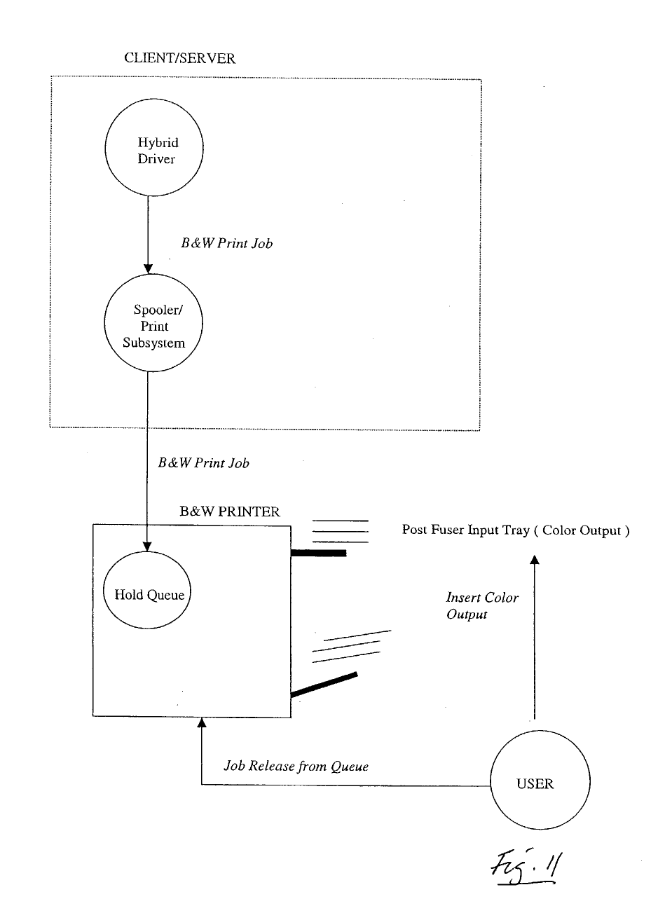

Following the discussion below which relates to FIGS. 2-5, discussion of the invention then continues with in-order discussions relating to FIGS. 6-11, inclusive. These figures generally picture the flow of a mixed-mode print job “through” the hybrid driver of this invention, and outwardly beyond the driver as single-mode jobs properly configured for appropriate printing. Variations and modifications are mentioned along the way to demonstrate the versatility of the invention, and further to demonstrate how all otherwise conventional and desirable print-job handling activities are neither compromised by, nor compromise in return, the efficient and effective performance of the proposed hybrid driver. By thus illustrating a full picture of job handling, the significant advantages of the driver of this invention can be appreciated. Those skilled in the art will recognize that the graphical depictions presented collectively by all of the drawing figures herein fully enable the implementation and practice of the present invention.

Referring to FIG. 2, a user selects all options relating to a print job from a single user interface. For example, the user might invoke this printer driver interface using a pull-down application file menu for print options, such as in the Microsoft Windows @ family of operating systems. From such a menu, the user would then select an installed printer from the printer selection menu.

Once the installed printer is selected, the user can select a printer-driver-specific menu, such as via a property page button on the printer selection menu, to access options specific to the hybrid printer driver of this invention.

FIG. 3 in the drawings illustrates hybrid printer driver characteristics including assembly matters, finishing matters, and selection of print media. Regarding these characteristics, the hybrid printer driver menu will include typically at least three sections represented by separate tab pages, as follows:

Media Input Type (stock, transparency, etc.)

Assembly (duplex, booklet, n-up, reverse, copies, collation, etc.)

Finishing (stapling, hole punch, folding, etc.)

This menu affords access to options and matters that are independent of color and black-and-white rendering. These options tend to be job whole.

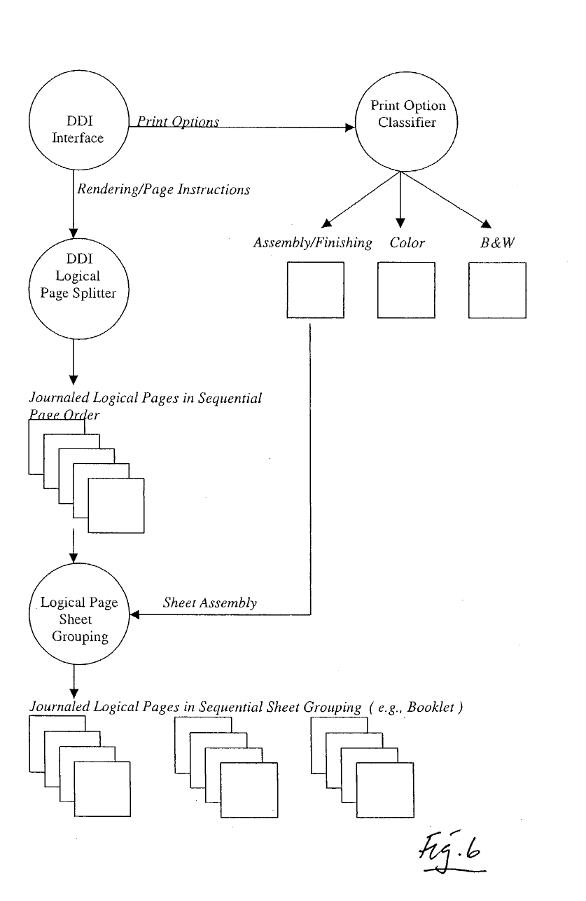

FIG. 4 presents the portion of the hybrid driver which contains options that are specific to color rendering. These options tend to be page specific, and to cover areas such as:

Trays (input and output trays, etc).

Print Depth (resolution, bits per pixel, etc.)

Color (color tables, color matching, calibration, etc.)

Half-toning

Toner usage

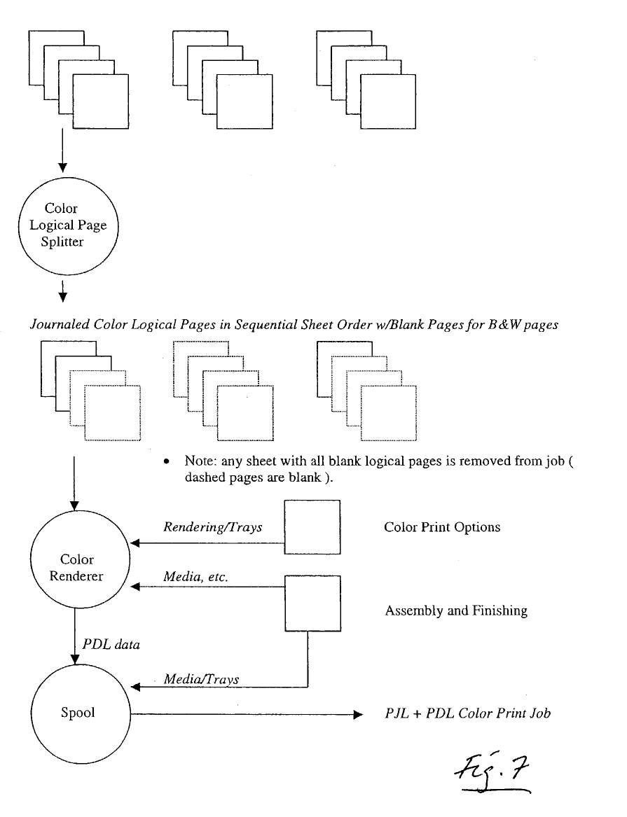

FIG. 5 generally shows the portion of the hybrid driver of this invention which contains options that are specific to black-and-white rendering, and that relate to the merging of the color output materials. These options tend to be page specific, and to cover areas such as:

Trays (input and output trays, color input tray etc).

Print Depth (resolution, bits per pixel, etc.)

Graphics

Half-toning

Toner usage

FIG. 6 gives an illustration of the practice of separation of job elements into logical pages. As shown here, the printing instructions based in operation of the hybrid printer driver are separated into print job requirements and logical pages. These instructions journal the logical pages (i.e., the printing instructions are saved w/o rendering until all of the logical pages have been input to the driver). Depending on the size of the journaled data, the logical pages may be saved in memory or on disk for optimal performance.

Print job requirements are analyzed and split into three groups:

1. Media/Assembly/finishing

2. Color Options

3. Black-and-White Options.

Page-specific printing instructions, obtainable via the DDI interface in the Microsoft Windows® family of operating systems, are journaled and split into logical pages (i.e., the source's concept of a page), and in sequential page order. Issues of persistent data (i.e., print data that persists across page boundaries) are appropriately handled (e.g., some print data may be duplicated from one logical page to another, etc.). If necessary, such as, for example, if a non-sequential page order assembly was specified for booklet printing, the logical pages are then re-sequenced according to the assembly options specified in the print job requirements.

Finally, the re sequenced logical pages are then grouped to form physical printed sheets according to the page layout and job assembly information. For example, in a normal order duplex print job using the same input media, each pair of logical pages, starting with page 1, and in sequential order, would be laid out and grouped into sheets. If the logical pages were re sequenced, the associated print job option might be modified to indicate that a required re sequencing portion of activity has already occurred. For example, in booklet printing, the requirement would be changed to 2-up duplex printing.

Turning now to FIG. 7, here there is an illustration of split color-job generation according to practice of the invention. As shown here, the previously identified logical pages are analyzed to determine which pages contain color, and which are entirely black-and-white. Any conventional algorithm for determining the input colors as black-and-white may be used for this purpose. For example, an RGB value of all zeros may be considered black, and an RGB value of all ones considered white. Other ascertaining methods include using thresholds and ranges, such as any RGB triplet values, where all values<10 or all values>245 of a possible maximum 255.

Two copies of the sheet-grouped logical pages are then made, one for the color job and the other for the black-and-white job. In the color job, each black-and-white logical page is replaced with a blank page. The sheets of logical color and blank pages are passed to the color renderer to produce PDL, or raster data, specific to the available color printing device (e.g., printable area, PDL, color tables, etc.). This is done according to the color options which were specified in the color menu, such as resolution, input tray, and media options, etc.

This rendering process may also consider the job as a whole, along with the assembly/finishing options, to make additional adjustments to the position of the logical pages to account for the effects of binding, such as hole punching and folding/trimming, etc.

Once the logical pages are converted to printer-specific format, any sheet that contains only blank logical pages is removed from the job. Finally, any print job options that are device implemented, i.e., not by the driver, are added to the print job, such as in PJL statements, except for finishing options (e.g., stapling, hole punch, folding, trimming, etc.).

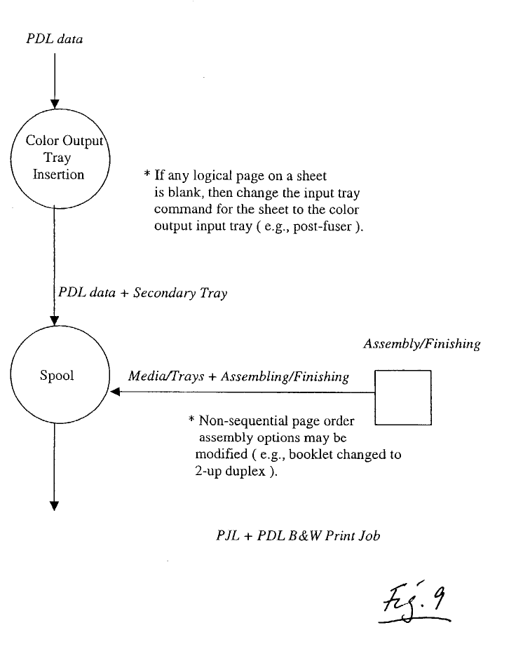

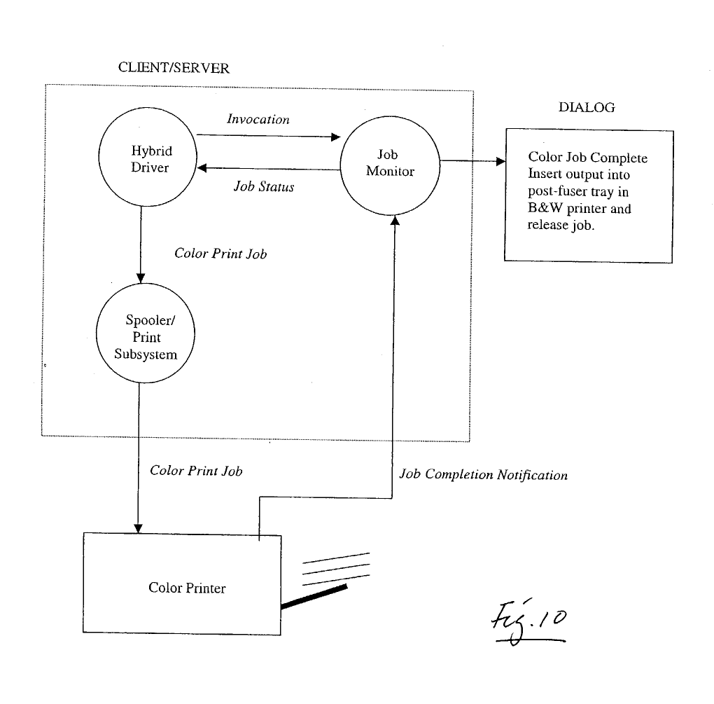

Addressing attention now to FIGS. 8 and 9, the sheets of logical black-and-white and blank pages are passed to the black-and-white renderer to produce PDL, or raster data, specific to the chosen black-and-white printing device (e.g., printable area, PDL, etc.). This is done according to the black-and-white options which were specified in the black-and-white driver menu, such as resolution, input tray, and media options, etc.

This rendering process may also consider the job as a whole, along with the assembly/finishing options, to make additional adjustments to the position of the logical pages on the sheets to account for the effects of binding, such as hole punching and folding/trimming.

Once the logical pages are converted to printer-specific format, any sheet that contains at least one blank logical page has its input tray command modified to pull the corresponding sheet from the color tray, such as a post-fuser tray, which tray was the color input tray specified in the black-and-white print menu.

Finally, any print job options that are device-implemented, and not by the driver, are added to the print job. Included, for example are PJL statements, such as finishing options (e.g., stapling, hole punch, folding, trimming, etc.).

The color print job can be spooled to the spooler for automatic printing (i.e., to be printed immediately upon arrival and reaching top of the job queue), without delay or manual intervention. The spooled job may then, either immediately, or appropriately delayed, be de-spooled to the proper printing device, with such de-spooling perhaps involving an intermediate device, such as a print or RIP server.

Preferably, the color printing device which is to be used has the capability to send notification back to the “client” that the color print job has successfully been output. One method for such notification involves embedding the IP address of the client, and the port number of a listening background process, into the print job. With this done, upon successful completion of the associated job, the color printer sends back a job-completed notification to the extracted LP address and port number

Preferably, the hybrid printer driver creates a background thread process, which may be asynchronous to the parent, which process listens for the job-completion notification on the designated port number. Once such a notification is received, indicating that the color job has been successfully output, a dialog is displayed to the user indicating the completion of the color job, accompanied by a request to insert the color output material manually into the secondary (e.g., post-fuser) tray of the black-and-white printer.

In an alternate approach, where the color printing device does not have a job-notification capability, the user manually waits for the output of the color job.

Once the color job is printed by the color printer, a user manually removes the sheets, and without any reshuffling or re-collation, the user inserts the sheets into a secondary input tray of the black-and-white printer. The sheets are inserted in such a manner (face and direction), that when the black-and-white printer pulls the color sheets and the blank sheets from the primary and secondary input trays, the merged output will be in the correct face and print direction.

Addressing attention now to FIG. 11, here there is illustrated de-spooling of the split black-and-white print job. This job is spooled to the spooler for interactive printing (i.e., is held in queue until manual release). The job may then, either immediately or in a suitably delayed fashion, be de-spooled to the black-and-white printing device. Such de-spooling may involve an intermediate device, such as a print or a RIP server. In the case of the presence of such an intermediate device, the print job may optionally be held in the print or RIP server queue if the printing device has the capability of pulling the job from an external queue. Preprocessing, such as rasterizing and job accounting, may also occur prior to release of the black-and-white job.

Once the color job output is inserted into the secondary input tray, the user then releases the black-and-white print job from the internal, or external, holding queue. Once the black-and-white job starts printing, sheets are then pulled either from the primary, or other designated trays, or from the secondary input tray (e.g., post-fuser), according to the media input instructions, whereby, the “job” pulls sheets containing at least one color-printed logical page from the secondary input in the appropriate sequence.

In an alternate approach, where the chosen black-and-white printing device does not have an internal or external holding-queue capability for interactive printing, the black-and-white job is held on the “client side”. For example, the hybrid printer driver may not immediately spool the print job to the spooler, or the associated print processor or port monitor may hold the job indefinitely after the spooler de-spools the print job.

The process on the client side that holds the black-and-white job would then display a dialog and prompt to the user, requesting that the user release the black-and-white print job after the color output is manually inserted into the black-and-white printer.

Thus, there are various ways and manners of implementing a hybrid driver, as proposed by the present invention, in the 1 settings pictured in FIGS. 1A and 1B. This unique driver, which may readily be designed for handling various kinds of mixed-mode print jobs, and which presents itself as a single, combined interface, offers an advanced and convenient tool for managing many kinds of mixed-mode print (imaging) jobs.

Variations and modifications have been illustrated and described, and many more are certainly possible and will be discerned by those skilled in the art—all of which variations and modifications come within the scope of this invention.

I claim:

1. A print job method comprising
encountering a plural, mixed-mode print job, and
utilizing an appropriate single, plural-mode printer driver, splitting the mixed-mode print job into plural, single-mode print jobs.

2. A print job method comprising
encountering a mixed black-and-white and color print job, and
utilizing a single, hybrid, dual-mode printer driver, splitting the encountered, mixed print job into two print jobs, one of which is a black-and-white print job, and the other of which is a color print job.

3. A method for splitting a mixed black-and-white and color print job into one job for black-and-white, and the other for color, comprising
establishing such a mixed print job,
in an overall job data stream relating to that established job, operatively introducing a single, dual-mode, hybrid, black-and-white and color printer driver, and
utilizing that driver, splitting the job into (a) a black-and-white print job, and (b) a color print job.

4. The method of claim 3 which further includes, after splitting, sending the split print job for printing by delivering the black-and-white print job to a black-and-white printer, and the color print job to a color printer.

5. The method of claim 3, wherein the overall print job data stream passes through an operable print de-spooling subsystem, and said splitting is performed in a manner whereby splitting is independent of the operation of that subsystem.

6. The method of claim 3, wherein the print job is characterized by a defined data format selected from a collection of plural, available data formats, and operation of the hybrid printer driver to split the job is independent of that format.

7. The method of claim 3 wherein further comprises presenting the hybrid printer driver to a user via a single user interface.

8. A system operable in conjunction with a mixed black-and-white and color print job for splitting that job into a black-and-white print job and a color print job comprising
upstream, print-job, data-stream structure operable to carry pre-split print-job data, and having a downstream region,
a single, dual-mode, hybrid, black-and-white and color printer driver operatively connected to said upstream data-stream structure to receive such pre-split print-job data from adjacent said upstream data-stream structure's downstream region, said driver being operable to split such received data into (a) a post-split, black-and-white, print-job data stream, and (b) a post-split, color, print-job data stream, and
downstream, print-job, data-stream structure including (a) a black-and-white data-stream substructure operatively connected to said hybrid printer driver to receive therefrom such a post-split, black-and-white data stream, and (b) a color data-stream substructure operatively connected to said hybrid printer driver to receive therefrom such a post-split, color data stream.

9. The system of claim 8, wherein said hybrid printer driver is constructed to present a single menu interface to a user.

10. The system of claim 8, wherein said hybrid printer driver is structured to function in a manner which is independent of any print-job data format.

11. A plural-mode, hybrid printer driver designed for operation in a print-job system which is intended to handle a plural-mode, mixed print job comprising
an input side adapted to receive such plural-mode, mixed print-job data,
splitting structure operatively connected to said input side and adapted to receive therefrom such input data, and to split such received data into plural, single-mode data streams, one for each mode, and
an output side including plural output regions each operatively connected to said splitting structure, with each region being specifically connected for receiving and outputting, from a different one of said split data streams, one each, different-mode, post-split, single-mode output print-job.

12. A dual-mode, hybrid printer driver designed for operation in a print-job system which is intended to handle a mixed black-and-white and color print job, comprising
an input side adapted to receive mixed print-job data in such a mixed print job,
splitting structure operatively connected to said input side to receive therefrom input, mixed, print-job data and to split such received data into two data streams, one of which contains black-and-white print-job data, and the other of which contains color print-job data and
an output side including two output regions each operatively connected to said splitting structure, with one of said output regions being so connected for receiving and outputting post-split, black-and-white, print-job data, and the other output region being so connected for receiving and outputting post-split, color, print-job data.

13. Print job structure comprising
encountering structure constructed to encounter a plural, mixed-mode print job, and
utilizing structure operatively connected to said encountering structure and operable to employ an appropriate, single, plural-mode printer driver for splitting the mixed-mode print job into plural, single-mode print jobs.

14. Print job apparatus comprising
encountering structure constructed for encountering a mixed black-and-white and color print job, and
utilizing structure operatively connected to said encountering structure and constructed for utilizing a single, hybrid, dual-mode printer driver to split the encountered, mixed print job into two print jobs, one of which is a black-and-white print job, and the other of which is a color print job.
